(19) United States
(12) Patent Application Publication
(10) Pub. No.: US 2012/0085958 A1
(43) Pub. Date: Apr. 12, 2012

(54) PLASTIC FORMED INFLATION MOUTH STRUCTURE

(76) Inventor: Teng-Jen YANG, Wufeng Shiang (TW)

(21) Appl. No.: 12/901,367

(22) Filed: Oct. 8, 2010

(51) Int. Cl. F16K 27/00

(52) U.S. Cl. 251/336

(57) ABSTRACT

A plastic formed inflation mouth structure comprises a plastic formed body which is integrally formed with an inflation mouth by plastic injection molding. The inflation mouth includes an inflation apparatus passage and a restoration unit that are integrally formed. The inflation apparatus passage unit is formed with a notch for passage of an inflation apparatus to perform the inflation or deflation. The restoration unit applies an elastic restoration force onto the notch to make the notch assuredly enclose the inflation apparatus during the inflation and ensure a high airtightness when inflation is stopped.

### BACKGROUND OF THE INVENTION

1. Field of the Invention

The present invention relates to an inflation device, and more particularly to a plastic formed inflation mouth structure.

2. Description of the Prior Art

Inflation structures are applied in various fields and on various objects. In order to adjust the air pressure in time, the inflation structures are normally provided with an inflation mouth structure or inflation valve which is connected to an inflation/deflation apparatus to perform the inflation or deflation.

Conventionally, the inflation mouth structure and the inflation structure are connected after they are formed, so that the structure defects are prone to occurring on the joint of the inflation mouth structure and the inflation structure. After a period of time, the joint of the inflation structure and the inflation mouth structure might be broken firstly, leading to the air loss and weakening the function of the inflation structure. If the inflation structure is applied on the safety device, such as swim ring or life jacket, it will endanger the user. In addition, since the inflation structure and the inflation mouth structure are connected together after being formed respectively, the corresponding procedures are quite complicated and don't cohere with economic benefits of quick mass production.

The present invention has arisen to mitigate and/or obviate the afore-described disadvantages.

### SUMMARY OF THE INVENTION

The primary objective of the present invention is to provide a plastic formed inflation mouth structure which has no structural defect since it is an integral structure and can reduce the production cost while enhancing the economic benefit since the manufacturing procedure is simply.

To achieve the above objective, a plastic formed inflation mouth structure in accordance with the present invention comprises a plastic formed body.

The plastic formed body is integrally formed with an inflation mouth, and the inflation mouth includes an inflation apparatus passage unit and a restoration unit that are integrally formed by injection molding.

The plastic formed body includes an inner surface and an outer surface;

The inflation apparatus passage unit protrudes from the inner surface of the plastic formed body, the inflation apparatus passage unit is a hollow structure and includes an inflation apparatus insertion space which is open toward the outer surface of the plastic formed body, the inflation apparatus passage unit is formed with a notch, an extending direction of the notch is defined as a notch direction.

The restoration unit and the inflation apparatus passage unit of the inflation mouth are integrally formed by plastic injection molding, the restoration unit produces an elastic restoration force in an elastic restoration force direction which is vertical to the notch direction, and the restoration unit applies the elastic restoration force to the notch from two opposite sides of the notch.

The plastic formed inflation mouth structure is integrally formed by injection molding, so that there is no joint between the plastic formed body and the inflation mouth, that is to say the plastic formed inflation mouth structure of the present invention has no structural defect, ensuring an optimal airtightness. The restoration unit assists closing the notch by its own elastic restoration force and further enhances the airtightness. Furthermore, the plastic formed inflation mouth structure is formed by the primary injection molding, so that it can be found that the manufacturing procedure is simply, reducing the production cost while enhancing the economic benefit.

### BRIEF DESCRIPTION OF THE DRAWINGS

FIG. 1 is a perspective view of a plastic formed inflation mouth structure in accordance with the present invention;

FIG. 2 is a partial cross-sectional view of the plastic formed inflation mouth structure in accordance with the present invention;

FIG. 3 is a partial top view of the plastic formed inflation mouth structure in accordance with the present invention;

FIG. 4 is an operational view showing that an inflation head is inserted in the plastic formed inflation mouth structure in accordance with the present invention;

FIG. 5 is an operational view showing that the inflation head is drawn out from the plastic formed inflation mouth structure in accordance with the present invention cooperates with inflation head;

FIG. 6 is a cross sectional view of an inflation mouth of the plastic formed inflation mouth structure in accordance with another embodiment of the present invention;

FIG. 7 is a cross sectional view of an inflation mouth of the plastic formed inflation mouth structure in accordance with another embodiment of the present invention;

FIG. 8 is a cross sectional view of an inflation mouth of the plastic formed inflation mouth structure in accordance with another embodiment of the present invention;

FIG. 9 is a cross sectional view of an inflation mouth of the plastic formed inflation mouth structure in accordance with another embodiment of the present invention;

FIG. 10A is a cross sectional view of an inflation mouth of the plastic formed inflation mouth structure in accordance with another embodiment of the present invention; and

FIG. 10B is a side view of FIG. 10A.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

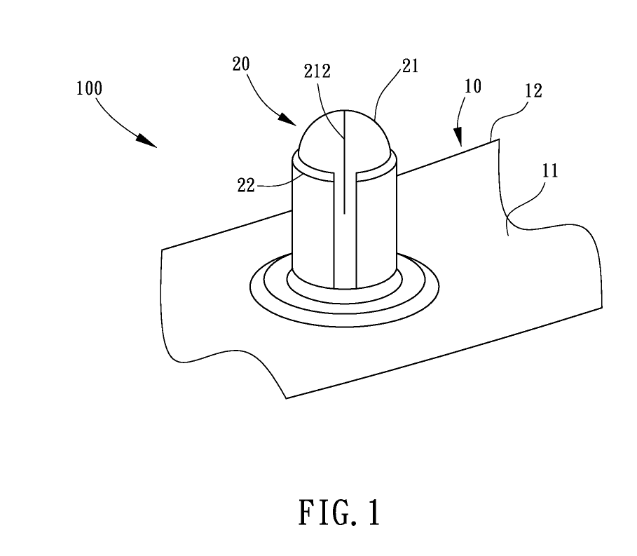

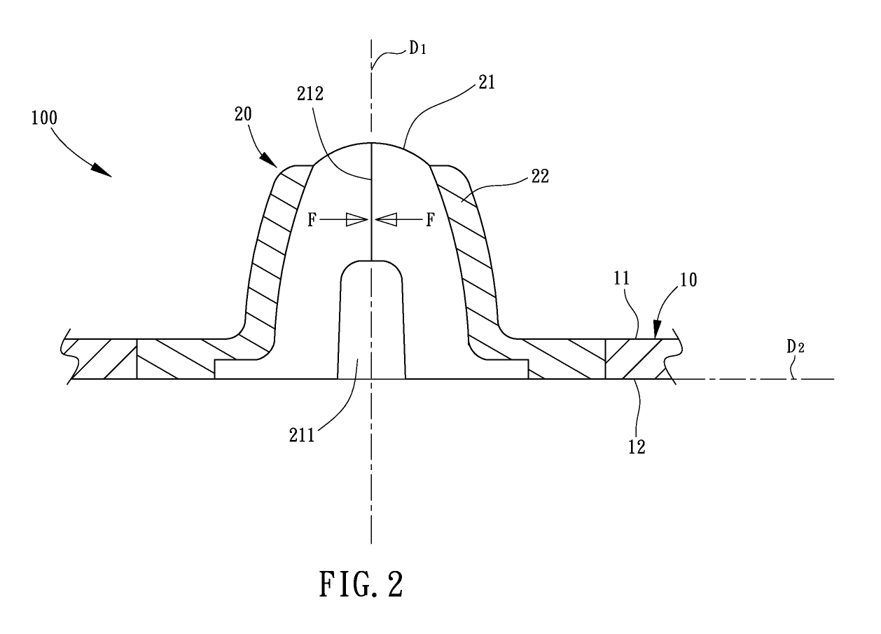

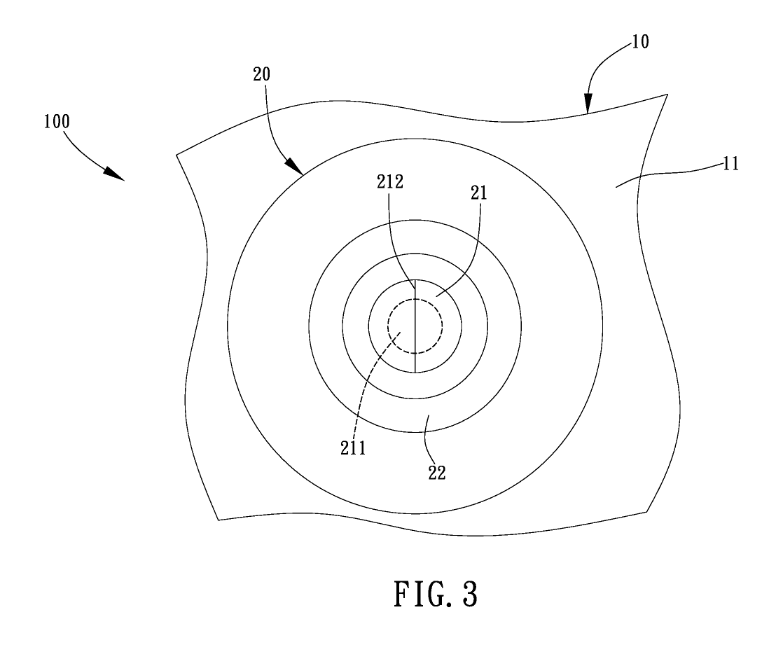

Referring to FIGS. 1-3, an inflation mouth structure 100 formed by plastic injection molding in accordance with the preferred embodiment of the present invention comprises a plastic formed body 10.

The plastic formed body 10 is integrally formed with an inflation mouth 20. The inflation mouth 20 includes an inflation apparatus passage unit 21 and a restoration unit 22 that are integrally formed.

The plastic formed body 10 includes an inner surface 11 and an outer surface 12.

The inflation apparatus passage unit 21 protrudes from the inner surface 11 of the plastic formed body 10. The inflation apparatus passage unit 21 is a hollow structure and includes an inflation apparatus insertion space 211 which is open toward the outer surface 12 of the plastic formed body 10. The inflation apparatus passage unit 21 is formed with a notch 212 in an end thereof protruding toward the inner surface 11 of the plastic formed body 10. An extending direction of the notch 212 is defined as a notch direction D1.

The restoration unit 22 and the inflation apparatus passage unit 21 of the inflation mouth 20 are integrally formed by plastic injection molding. The restoration unit 22 produces an elastic restoration force F in an elastic restoration force direction D2 which is vertical to the notch direction D1. The restoration unit 22 applies the elastic restoration force F to the notch 212 from two opposite sides of the notch 212. The restoration unit 22 fully encloses an outer periphery of the inflation apparatus passage unit 21 in the present embodiment. In addition, the restoration unit 22 can also partially enclose the outer periphery of the inflation apparatus passage unit 21 with the notch 212 exposed. The plastic formed body 10, the inflation apparatus passage unit 21 and the restoration unit 22 are all formed by the plastic injection molding. The elastic restoration ability of the restoration unit 22 is greater than that of the inflation apparatus passage unit 21. The restoration unit 22 and the inflation apparatus passage unit 21 are made of different characteristics of plastic materials in the present embodiment.

The aforementioned is the summary of the positional and structural relationship of the respective components of the preferred embodiment in accordance with the present invention.

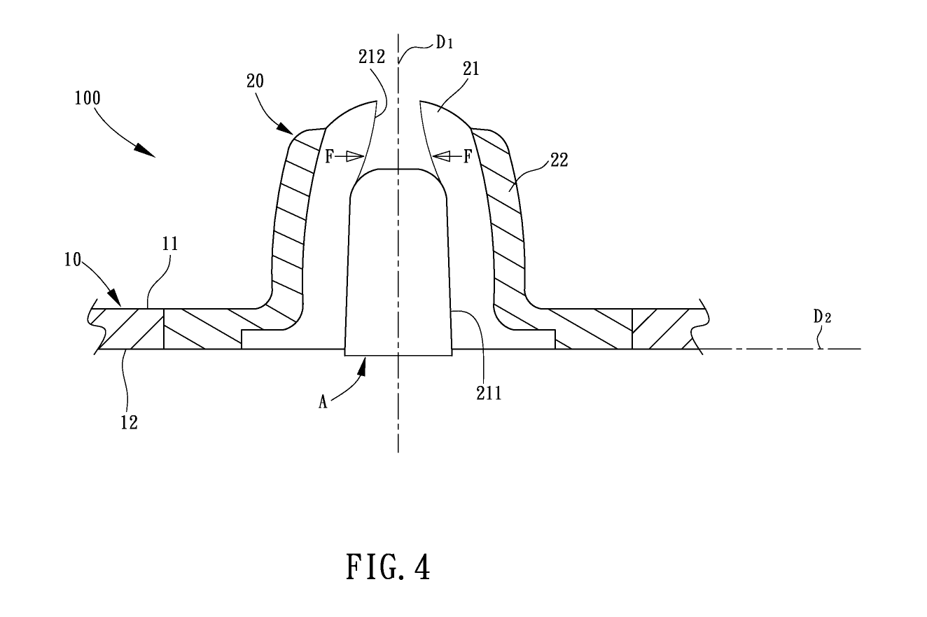

When in use, an inflation head A of an inflation apparatus is inserted into the inflation apparatus insertion space 211 of the inflation apparatus passage unit 21 from the outer surface 12 of the plastic formed body 10 and further extend through the notch 212 of the inflation apparatus passage unit 21. As shown in FIG. 4, the inflation head A of the inflation apparatus will prop the notch 212 open and penetrate the plastic formed body 10. At this moment, the inflation head A can perform the inflation. Since the inflation head A props the notch 212 of the inflation apparatus passage unit 21 open, the inflation apparatus passage unit 21 will correspondingly apply a force onto the restoration unit 22 to make it expand outwards. Further, since the elastic restoration force F is applied onto the notch 212 from the two sides of the notch 212, although the inflation head A props the notch 212 open during the inflation process, the restoration unit 22 will force the notch 212 to abut against the inflation head A closely without causing clearance between the inflation head A and the notch 212, avoiding the gas leakage.

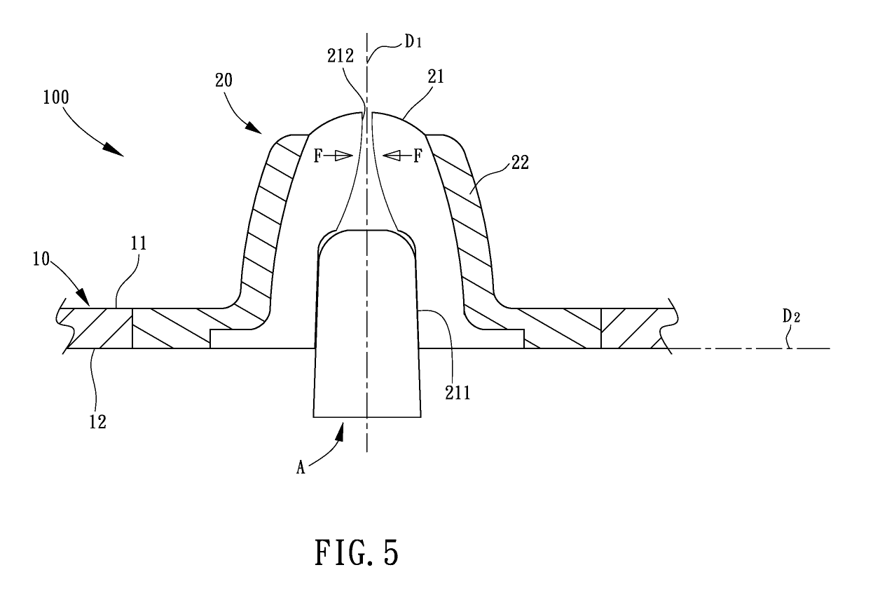

After finishing the inflation, the user can draw the inflation head A of the inflation apparatus out. When the inflation head A disengages from the notch 212, the elastic restoration force F will be continuously applied on the notch 212 to close the notch 212 quickly. As shown in FIG. 5, after the inflation head A completely disengage from the notch 212, the restoration unit 22 will make the notch 212 restore to its original closed state, preventing the gas from leaking through the notch 212.

Since the plastic formed inflation mouth structure 100 is formed just by the plastic injection molding, the corresponding manufacturing procedure is quite simply. In addition, the plastic formed inflation mouth structure 100 has no structural defects since it is formed as an integral structure. In addition, there is no open clearance between the plastic formed body 10, the inflation apparatus passage unit 21 and the restoration unit 22, ensuring a high aitightness.

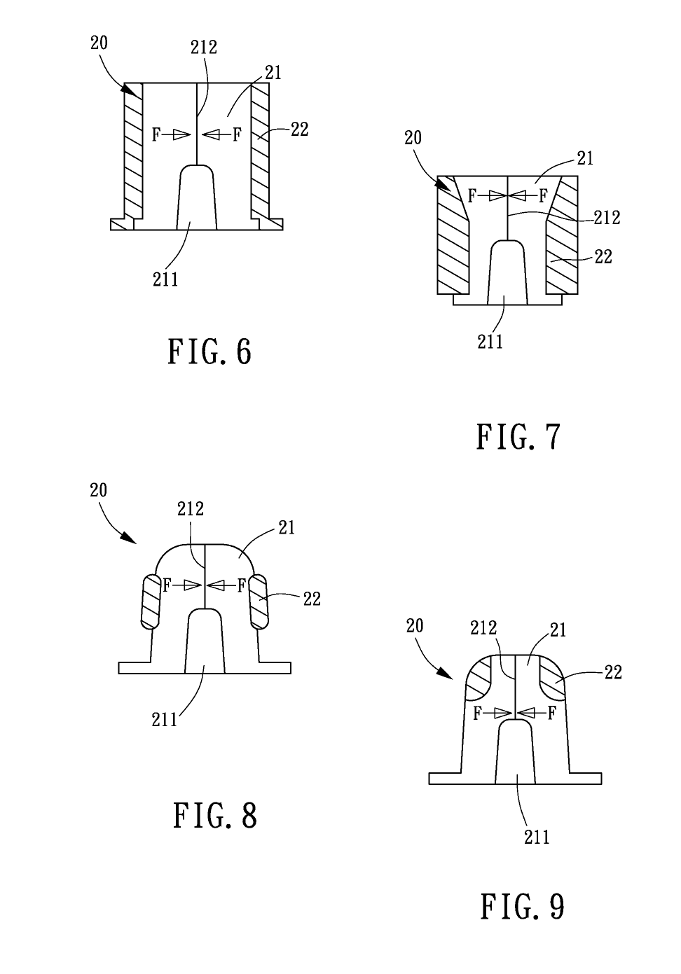

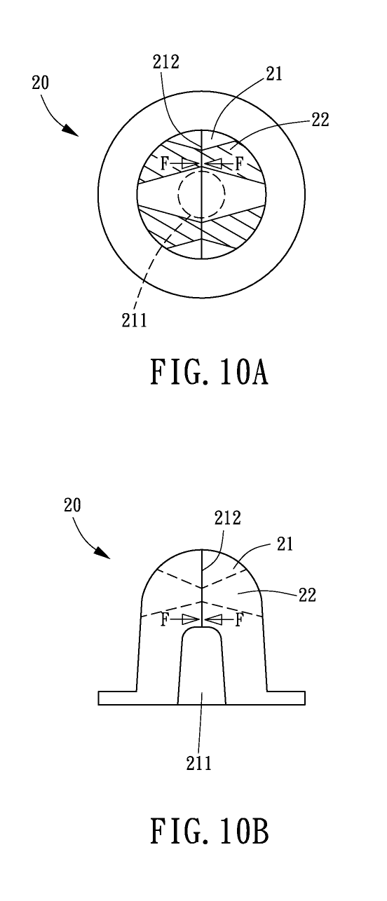

The restoration unit 22 in accordance with the present invention is not limited to being disposed at position as shown in the previous embodiment. As shown in FIG. 6, the restoration unit 22 of the inflation mouth 20 encloses two opposite sides of the inflation apparatus passage unit 21 with the notch 212 exposed. As shown in FIG. 7, the restoration unit 22 can also be slantways disposed at two opposite sides of a top end of the inflation apparatus unit 21. As shown in FIG. 8, the restoration unit 22 can also be just disposed at two opposite sides of an outer periphery of the inflation apparatus unit 21. As shown in FIG. 9, the restoration unit 22 can also be disposed at two opposite sides of a top end of the inflation apparatus unit 21. Furthermore, the restoration unit 22 can also be inserted in two opposite sides 212 of the inflation apparition passage unit 21. Specifically, the restoration units 22 in the respective embodiments of the present invention are all integrally formed with the inflation apparatus passage unit 21 and disposed at two opposite sides of the notch 212, so that the restoration unit 22 can apply the elastic restoration force F onto the notch 212.

While we have shown and described various embodiments in accordance with the present invention, it is clear to those skilled in the art that further embodiments may be made without departing from the scope of the present invention.

What is claimed is:

1. A plastic formed injection mouth structure comprising:
a plastic formed body integrally formed with an inflation mouth, the inflation mouth including an inflation apparatus passage unit and a restoration unit that are integrally formed by injection molding; wherein:
the plastic formed body includes an inner surface and an outer surface;
the inflation apparatus passage unit protrudes from the inner surface of the plastic formed body, the inflation apparatus passage unit is a hollow structure and includes an inflation apparatus insertion space which is open toward the outer surface of the plastic formed body, the inflation apparatus passage unit is formed with a notch, an extending direction of the notch is defined as a notch direction; and
the restoration unit and the inflation apparatus passage unit of the inflation mouth are integrally formed by plastic injection molding, the restoration unit produces an elastic restoration force in an elastic restoration force direction which is vertical to the notch direction, the restoration unit applies the elastic restoration force to the notch from two opposite sides of the notch.

2. The plastic formed injection mouth structure as claimed in claim 1, wherein the restoration unit of the inflation mouth is disposed at two opposite sides of the notch.

3. The plastic formed injection mouth structure as claimed in claim 2, wherein the restoration unit of the inflation mouth fully encloses an outer periphery of the inflation apparatus unit.

4. The plastic formed injection mouth structure as claimed in claim 2, wherein the restoration unit partially encloses an outer periphery of the inflation apparatus passage unit with the notch exposed.

5. The plastic formed injection mouth structure as claimed in claim 2, wherein the restoration unit of the inflation mouth is disposed at two opposite sides of a top end of the inflation apparatus passage unit.

6. The plastic formed injection mouth structure as claimed in claim 2, wherein the restoration unit of the inflation mouth is disposed at two opposite sides of an outer periphery of the inflation apparatus passage unit.

7. The plastic formed injection mouth structure as claimed in claim 2, wherein the restoration unit of the inflation mouth is slantways disposed at two opposite sides of a top end of the inflation apparatus passage unit.

8. The plastic formed injection mouth structure as claimed in claim 2, wherein the restoration unit of the inflation mouth is inserted in two opposite sides of the inflation apparatus passage unit.

9. The plastic formed injection mouth structure as claimed in claim 1, wherein an elastic restoration ability of the restoration unit of the inflation mouth is greater than that of the inflation apparatus passage unit.

10. The plastic formed injection mouth structure as claimed in claim 1, wherein the restoration unit and the inflation apparatus passage unit of the inflation mouth are made of different characteristics of plastic materials.

11. The plastic formed injection mouth structure as claimed in claim 1, wherein the inflation apparatus passage unit is formed with the notch in an end thereof protruding toward the inner surface of the plastic formed body.
